(19) United States
(12) Patent Application Publication
(10) Pub. No.: US 2005/0136546 A1
(43) Pub. Date: Jun. 23, 2005

(54) Microtiter plate, system and method for processing samples

(76) Inventors: Peter Berndt, Basel (CH); Gregor Dernick, Grenzach-Wyhlen (DE); Christof Fattinger, Blauen (CH); Remo Anton Hochstrasser, Oberwil (CH); Dieter Voegelin, Sissach (CH)

Correspondence Address: HOFFMANN-LA ROCHE INC.;PATENT LAW DEPARTMENT, 340 KINGSLAND STREET, NUTLEY, NJ, 07110, US

(21) Appl. No.: 11/010,806

(22) Filed: Dec. 13, 2004

(30) Foreign Application Priority Data
Dec. 22, 2003 (EP) 03079157.8

(51) Int. Cl. B01L 3/00

(52) U.S. Cl. 436/45; 422/102

(57) ABSTRACT

A microtiter plate for processing samples, having a liquid component or a liquid and a solid component or a liquid and a gel component, comprising: a single piece body which has an array of cavities, each cavity having an open upper end, a closed bottom end, and a bottom inner surface and comprises a first chamber for receiving a predetermined volume of a sample to be processed, a second chamber and a passage which fluidically connects the first and second chambers with each other, and a region in the lower part of passage adjacent to the bottom end of the cavity, the region so configured and dimensioned that it allows passage of liquid from one of said chambers to the other only when a centrifugal force is applied to the microtiter plate, but does not allow passage of any solid or gel component the size of which is larger than the width of the region.

### BACKGROUND OF THE INVENTION

Microtiter plates are multi-well plates that are adapted for receiving samples to be processed at a plurality of wells. Each well defines a reaction site where a sample is usually mixed with one or more reagents in order to form a sample-reagent mixture which is the subject to analysis e.g. by means of a photometer or a fluorometer.

In recent developments in the field of processing large numbers of samples that have a liquid component or a liquid and a solid component or a liquid and a gel component there is a need for a device that makes possible to separate the liquid from the solid or gel component of each sample rapidly and at low cost. There is in particular a need for a device of this kind which is suitable for processing in the latter way individual samples of very low volume, e.g. lower than 30 microliter.

### SUMMARY OF THE INVENTION

The invention provides a microtiter plate that is configured and dimensioned for performing the above-mentioned separations for a large number of samples rapidly and at low cost.

The invention also concerns a microtiter plate for processing samples having a liquid component or a liquid and a solid component or a liquid and a gel component.

The invention further concerns a system for processing samples having a liquid component or a liquid and a solid component or a liquid and a gel component.

The invention further concerns a method for processing samples having a liquid component or a liquid and a solid component or a liquid and a gel component.

According to a first aspect of the invention the above aim of the invention is attained with a microtiter plate of the above mentioned kind comprising
a single piece body, which is made by injection molding
said body having an array of cavities and
   each of said cavities having an open upper end and a closed bottom end,
   each of said cavities having a bottom inner surface and comprising a first chamber for receiving a predetermined volume of a sample to be processed, a second chamber and a passage which fluidically connects said first and second chambers with each other, said passage having a top opening,
   said first chamber, said second chamber and said passage having each a bottom inner surface which is portion of the bottom inner surface of said cavity,
   a region in the lower part of said passage being adjacent to the bottom end of the cavity, said region being so configured and dimensioned that it allows passage of liquid from one of said chambers to the other only when a centrifugal force is applied to the microtiter plate, but does not allow passage of any solid or gel component the size of which is larger than the width of said region.

According to a second aspect of the invention the above aim of the invention is attained with a system for processing samples having a liquid component or a liquid and a solid component or a liquid and a gel component, said system comprising a microtiter plate according to the invention.

According to a third aspect of the invention the above aim of the invention is attained with a method for processing samples having a liquid component or a liquid and a solid component or a liquid and a gel component, said method comprising
(a) introducing a predetermined volume of a sample, for example a sample comprising one or more biomolecules, having a liquid component or a liquid and a solid component or a liquid and a gel component into a first chamber of a cavity of a microtiter plate according to the invention,
(b) centrifugating the microtiter plate for transferring liquid from said first chamber to said second chamber, the liquid component of said sample being thereby entirely removed from said first chamber leaving therein only the solid or gel component of the sample.

According to a fourth aspect of the invention the above aim of the invention is attained with a method for processing samples having a liquid component or a liquid and a solid component or a liquid and a gel component, said method comprising
(a) introducing a predetermined volume of a sample, for example a sample comprising one or more biomolecules, having a liquid component or a liquid and a solid component or a liquid and a gel component into a first chamber of a cavity of a microtiter plate according to the invention,
(b) fluidically connecting one end of a pipetting tip with a second chamber of a cavity of a microtiter plate according to the invention,
(c) performing pipetting operations on said sample with said pipetting tip for either transferring liquid from said first chamber to said second chamber or for adding and/or removing a liquid to respectively from said first chamber and/or said second chamber.

### BRIEF DESCRIPTION OF THE FIGURES

The subject invention will now be described in terms of its preferred embodiments with reference to the accompanying drawings. These embodiments are set forth to aid the understanding of the invention, but are not to be construed as limiting.

FIG. 1 shows a perspective view of a microtiter plate 11 according to the invention.

FIG. 2 shows an enlarged view of part 11 of microtiter plate 11 in FIG. 1.

FIG. 3 shows a partial cross-sectional view of microtiter plate 11 along plane III-III in FIG. 2.

FIG. 4 shows the same view of microtiter plate 11 as FIG. 3a, but shows in addition a pipetting tip inserted in chamber 17.

FIG. 5 shows a partial cross-sectional view of microtiter plate 11 along plane V-V in FIG. 2.

FIG. 6 shows an enlarged cross-sectional view of a part of FIG. 3.

FIG. 7 shows a partial cross-sectional view of microtiter plate 11 along plane VI-VI in FIG. 6.

FIG. 8 shows a partial cross-sectional view of microtiter plate 11 along plane VII-VII in FIG. 6.

FIG. 9 shows a top view of a portion of microtiter plate 11 in FIG. 1.

### REFERENCE NUMBER LIST

11 microtiter plate
12 single piece body
13 cavity
14 upper end of cavity 13
15 bottom end of cavity 13
16 first chamber of cavity 13
17 second chamber of cavity 13
18 passage
19 top opening of passage 18
21 zone of passage 18
22 bottom of second chamber 17
23 bottom of first chamber 16
24 top side of microtiter plate 11
25 coating of bottom of passage 18
26 zone of minimum width of passage 18
27 circular line portion
28 circular line portion
29 bottom of passage 18
31 curved line portion
32 curved line portion
33 pipetting tip
34 sealing means
35 side edge of microtiter plate 11
36 side edge of microtiter plate 11
37 solid element

### DETAILED DESCRIPTION OF PREFERRED EMBODIMENTS

### DETAILED DESCRIPTION

The invention concerns a microtiter plate for processing samples having a liquid component or a liquid and a solid component or a liquid and a gel component, a system for processing samples having a liquid component or a liquid and a solid component or a liquid and a gel component, and a method for processing samples having a liquid component or a liquid and a solid component or a liquid and a gel component.

According to a first aspect of the invention the above aim of the invention is attained with a microtiter plate of the above mentioned kind comprising
a single piece body, which is made by injection molding,
said body having an array of cavities and
   each of said cavities having an open upper end and a closed bottom end,
   each of said cavities having a bottom inner surface and comprising a first chamber for receiving a predetermined volume of a sample to be processed, a second chamber and a passage which fluidically connects said first and second chambers with each other, said passage having a top opening,
   said first chamber, said second chamber and said passage having each a bottom inner surface which is portion of the bottom inner surface of said cavity,
   a region in the lower part of said passage being adjacent to the bottom end of the cavity, said region being so configured and dimensioned that it allows passage of liquid from one of said chambers to the other only when a centrifugal force is applied to the microtiter plate, but does not allow passage of any solid or gel component the size of which is larger than the width of said region.

According to a second aspect of the invention the above aim of the invention is attained with a system for processing samples having a liquid component or a liquid and a solid component or a liquid and a gel component, said system comprising a microtiter plate according to the invention.

According to a third aspect of the invention the above aim of the invention is attained with a method for processing samples having a liquid component or a liquid and a solid component or a liquid and a gel component, said method comprising
(a) introducing a predetermined volume of a sample, for example a sample comprising of one or more biomolecules, having a liquid component or a liquid and a solid component or a liquid and a gel component into a first chamber of a cavity of a microtiter plate according to the invention,
(b) centrifugating the microtiter plate for transferring liquid from said first chamber to said second chamber, the liquid component of said sample being thereby entirely removed from said first chamber leaving therein only the solid or gel component of the sample.

According to a fourth aspect of the invention the above aim of the invention is attained with a method for processing samples having a liquid component or a liquid and a solid component or a liquid and a gel component, said method comprising
(a) introducing a predetermined volume of a sample, for example a sample comprising of one or more biomolecules, having a liquid component or a liquid and a solid component or a liquid and a gel component into a first chamber of a cavity of a microtiter plate according to the invention,
(b) fluidically connecting one end of a pipetting tip with a second chamber of a cavity of a microtiter plate according to the invention,
(c) performing pipetting operations on said sample with said pipetting tip for either transferring liquid from said first chamber to said second chamber or for adding and/or removing a liquid to respectively from said first chamber and/or said second chamber.

The following examples are provided for illustrative purposes and are not intended to limit the scope of applicants' invention.

### EXAMPLE OF A MICROTITER PLATE FOR PROCESSING SAMPLES

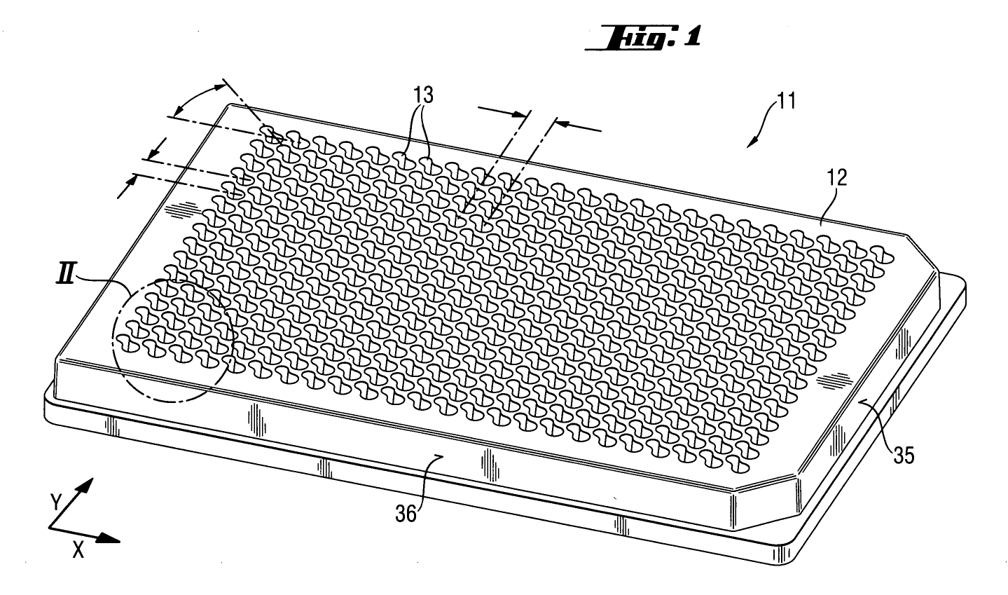

FIG. 1 shows a microtiter plate 11 according to the invention for processing samples comprising biomolecules to be analyzed, and further having a liquid component or a liquid and a solid component or a liquid and a gel component.

A sample of the above mentioned kind is processed in a cavity of the microtiter plate and such processing includes steps which have the effect of extracting biomolecules to be analyzed from the solid or gel component of the sample and transferring those biomolecules to the liquid component of the sample. After this step the liquid component carrying the biomolecules to be analyzed is separated from the solid or gel component of the sample as described in detail hereinafter. This separation is the main aim of the instant invention.

The term “liquid component” comprises any liquid containing biomolecules in solution or any liquid containing a solid component and/or a gel component to form a suspension.

The term “solid component” comprises a solid in the suspension that shall be separated by the proposed structure and method, e.g., chromatography beads.

The term “gel component” comprises one or more pieces of agarose or polyacrylamide gel or another gel. The size of the gel component is limited by the size of the cavity and the size of the connecting structure between the two cavities.

The maximum size of the solid or gel component of the sample is limited by the size of the cavity of the microtiter plate. The minimum size of the solid or gel component that can be separated from the liquid component is limited by the size of the passage which connects said first and second chamber of the cavity with each other.

The term “biomolecule” comprises all organic molecules, including macromolecules, found in living organisms and in particular, proteins, peptides, DNA, RNA and metabolites thereof.

As used herein, the term “having” is equivalent to the term, and shall have the meaning of the term, comprising.

Microtiter plate 11 comprises a single piece body 12. The single piece body 12 is made by injection molding of a suitable plastic material, e.g. Polypropylene (PP), Cyclic Olefin Copolymer (COC), Acrylonitrile/Butadien/Styrene (ABS), Polycarbonate (CC) or Polystyrene (PS), or of other materials known to one of ordinary skill in the art.

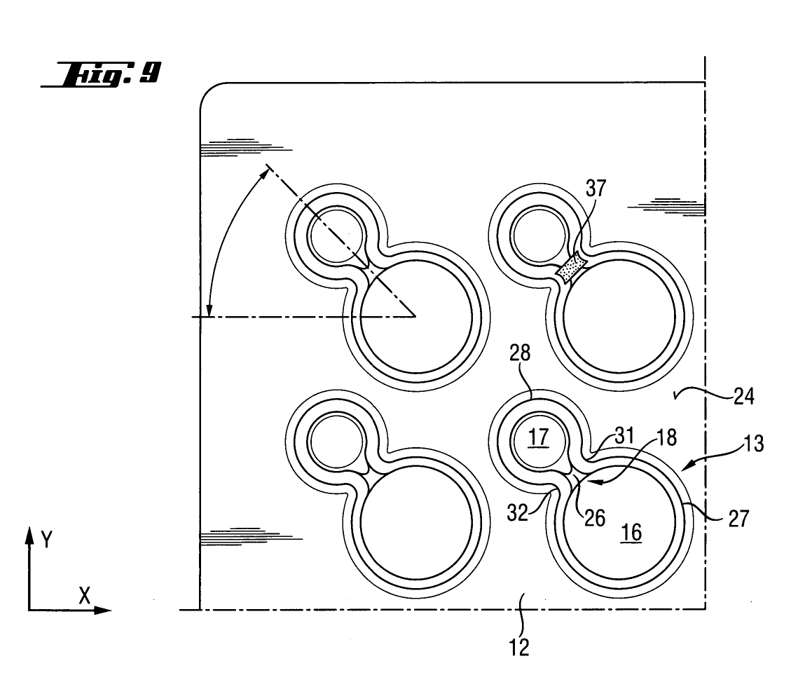

Body 12 has an array of cavities 13 and side edges 35, 36. In a preferred embodiment, the grid spacing is of e.g. 4.5 millimeter measured along each of edges 35, 36, i.e. in both X-direction and Y-direction shown by arrows in FIGS. 1 and 9.

As shown in particular by FIGS. 1 and 9, the cross-section of each of cavities 13 has a length axis which forms an angle A of about 45 degrees with a side edge 35, 36 of the microtiter plate 11. This spatial arrangement of cavities makes possible to form a relatively large number of such cavities in a microtiter plate of standard size as known to one of ordinary skill in the art. In a preferred embodiment, the standard size plate has e.g. a length of about 127.76±0.25 millimeter and a width of about 85.48±0.25 millimeter.

In a preferred embodiment, single piece body 12 has standard outer dimensions of a microtiter plate and comprises 384 cavities 13. In another preferred embodiment, single piece body 12 has standard outer dimensions of a microtiter plate and comprises 1536 cavities 13. In yet another preferred embodiment, single piece body 12 has standard outer dimensions of a microtiter plate and comprises 96 cavities.

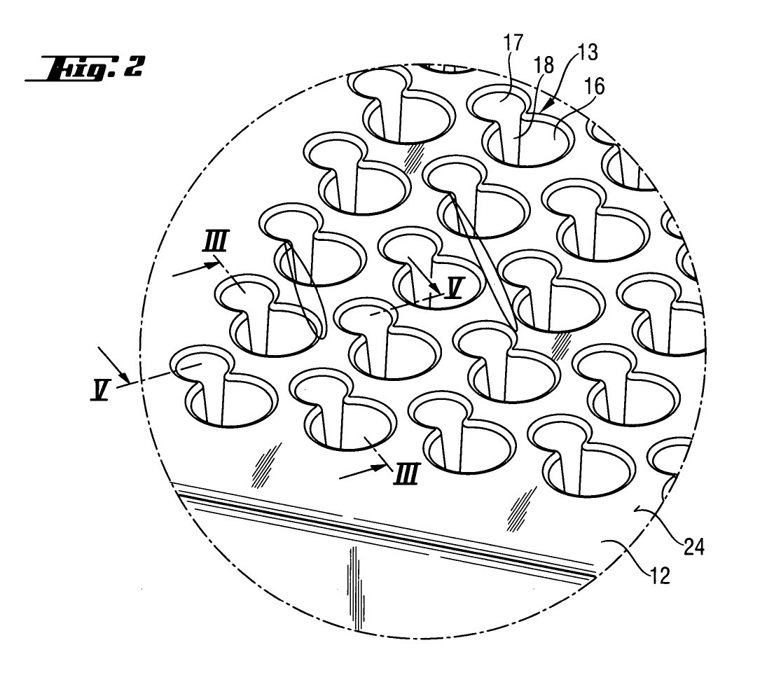

As shown in particular by FIGS. 1, 2 and 9 each of cavities 13 has an inner surface the cross-section of which is a closed curve and the inner surface has no corner or sharp edge. In a preferred embodiment the closed curve has approximately the shape of two circular line portions 27, 28 connected with each other by curved line portions 31, 32.

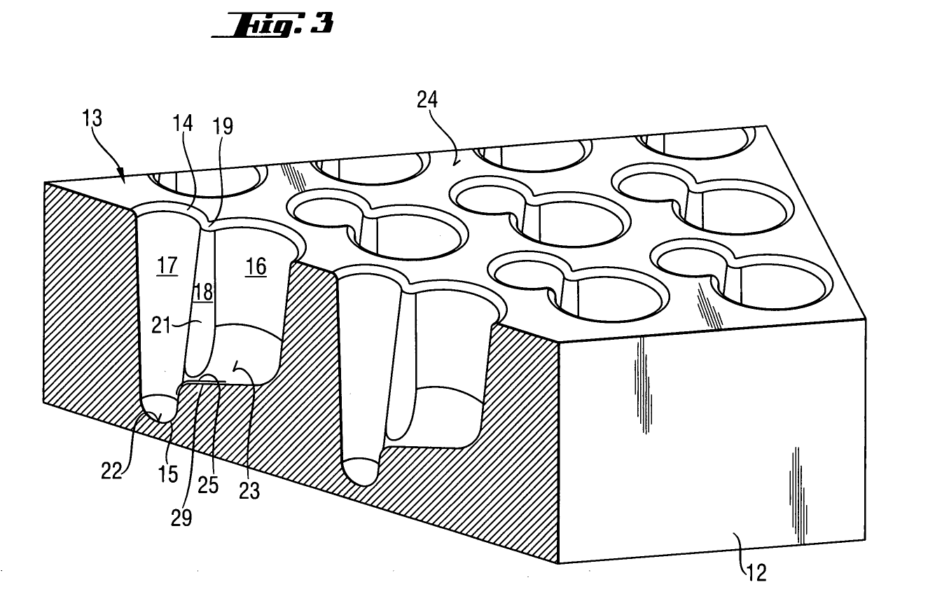

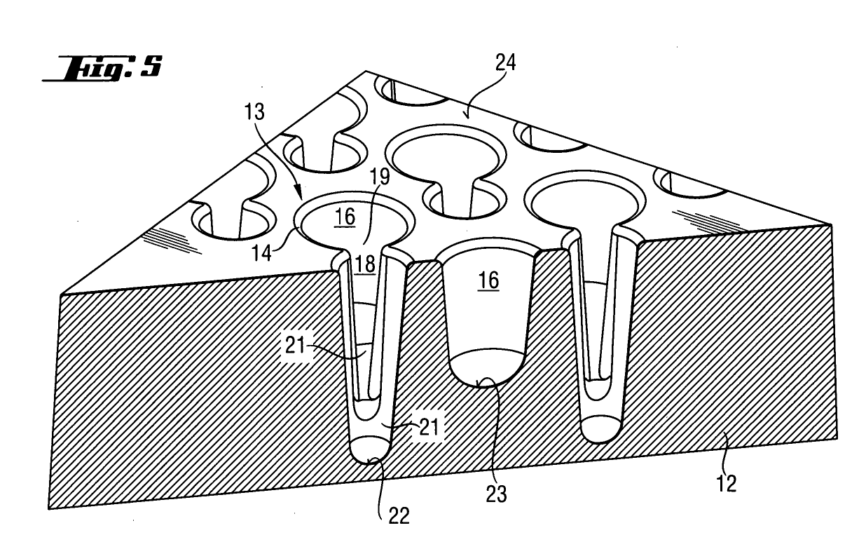

As shown by FIGS. 3 to 8, each of cavities 13 has an open upper end 14 and a closed bottom end 15 and each of cavities 13 has a bottom inner surface and comprises a first chamber 16 for receiving a predetermined volume of a sample to be processed, a second chamber 17 and a passage 18 which fluidically connects chambers 16 and 17 with each other. Passage 18 has a top opening 19. The total volume of a cavity 13 is e.g. about 30 microliter. The bottom 23 of chamber 16, the bottom 22 of chamber 17 and the bottom of passage 18 have each an inner surface which is a portion of the inner surface of the bottom 15 of cavity 13.

Chambers 16, 17 and passage 18 have side walls with an inclination angle of about 4 degrees.

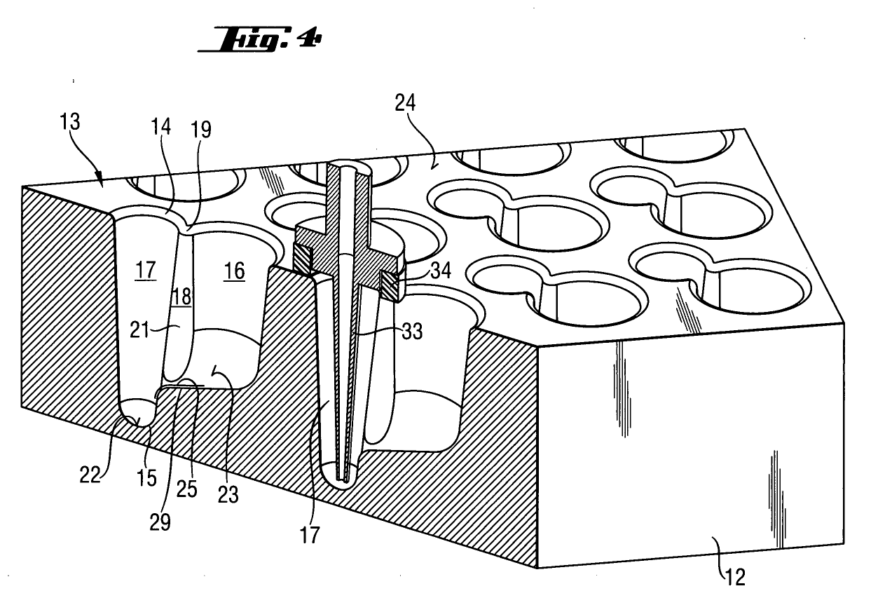

In a preferred embodiment, chamber 16 is adapted for receiving a sample having a liquid component or a liquid and a solid component or a liquid and a gel component, whereas chamber 17 is adapted for receiving a pipetting tip 33 shown by FIG. 4.

In a preferred embodiment microtiter plate 11 further comprises sealing means 34, shown in FIG. 4, which seal the contact surface of tip 33 with the microtiter plate 11 and second sealing means (not shown) which seal the top opening of passage 18.

As shown in particular by FIGS. 1, 2 and 9, passage 18 has a variable width in a direction extending from chamber 16 to chamber 17 and that width has a minimum at a zone 26 located between chambers 16 and 17.

A region 21 in the lower part of passage 18 is adjacent to the bottom end 15 of the cavity 13. Region 21 is so configured and dimensioned that it allows passage of liquid from one of chambers to the other only when a centrifugal force is applied to the microtiter plate, but does not allow passage of any solid or gel component the size of which is larger than the width of region 21.

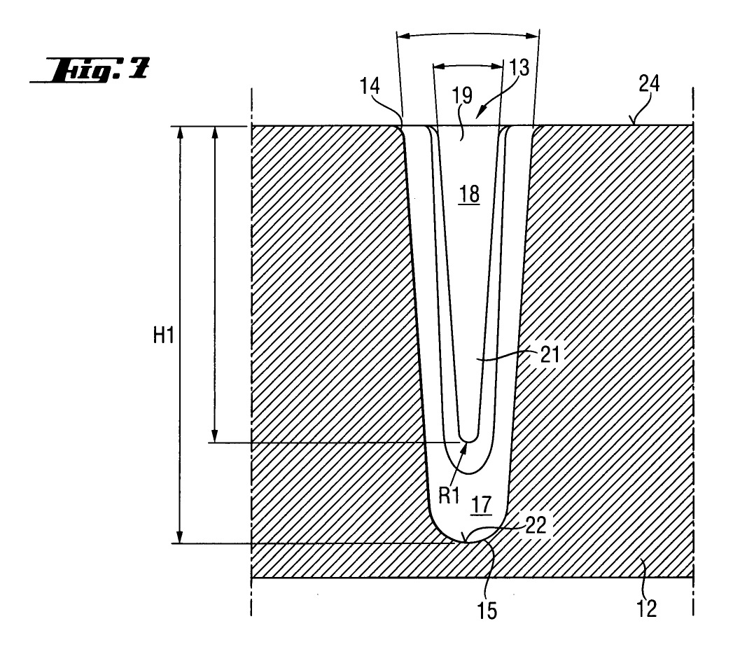

In a preferred embodiment, region 21 of passage 18 is configured and dimensioned as a capillary passage adapted for supporting or facilitating flow of liquid from one of chambers 16, 17 to the other. This is for instance the case when the entire length of region 21 is a capillary adapted for receiving liquid and is thereby able to provide a fluidic connection between the bottom of chamber 16 and the bottom of chamber 17. The bottom of passage 18 (shown in FIG. 7) has a radius R1, e.g. R1=0.3 millimeter. The radius R1 is preferably comprised e.g. in a range between 0.1 to 0.5 millimeter.

In another preferred embodiment, region 21 of passage 18 is configured and dimensioned as a capillary passage adapted for preventing a displacement of a solid or gel component of the sample through passage 18.

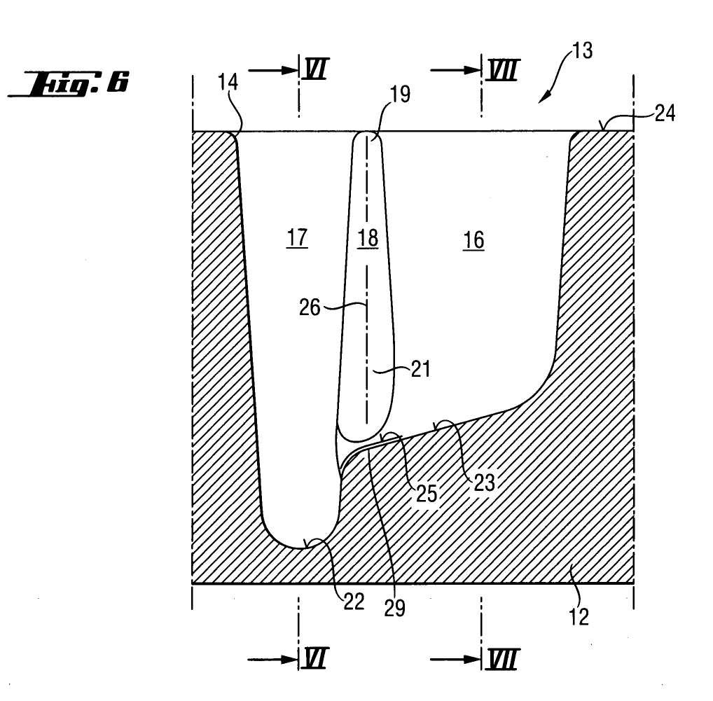

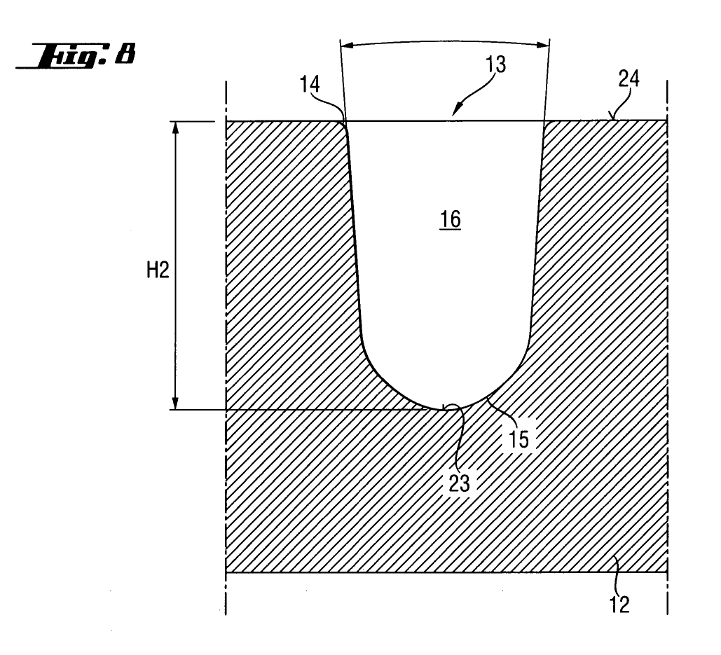

As shown by FIGS. 3 to 6, in a preferred embodiment the bottom 22 of chamber 17 lies at a lower level than the bottom 23 of first chamber 16 when the microtiter plate 11 is in horizontal position and the upper ends 14 of chambers are on the top side 24 of the microtiter plate 11. As shown by FIG. 6, the bottom of chamber 16 has an inclination of about 20 degrees with respect to the top side 24 of plate 11. As shown by FIG. 7, the deepest point of the bottom of chamber 17 has a depth H1. As shown by FIG. 8, chamber 16 has a depth H2, that is smaller than that of H1 (for example, H1=about 5 mm, H2=about 4 mm). The depth of H1 and H2, respectively are determined by the taper of the body chambers, the distance from chamber 16 to 17, and the angle of inclination in chamber 17.

In a preferred embodiment the inner surface of the bottom 29 of passage 18 which fluidically connects chambers 16 and 17 with each other has a shape that contributes to maximize the centrifugal force exerted on a sample contained in first chamber 16 when microtiter plate 11 is centrifuged by means of a centrifugation apparatus. FIG. 6 shows such a shape of the bottom 29 of passage 18.

In a preferred embodiment of microtiter plate 11 at least a portion of the inner surface of the bottom of each of said cavities 13 is a hydrophilic or hydrophobic surface, or is a surface having a hydrophilic or hydrophobic coating. The purpose of these surface properties is to create flow conditions that are suitable for the intended use of the microtiter plate, e.g. when a preferred sense of flow is suitable for the desired liquid handling process.

In a preferred embodiment at least a portion of or the entire inner surface of the bottom 29 of passage 18 is a hydrophilic surface or is a surface having a hydrophilic coating 25 shown by FIG. 6. This feature facilitates the flow of liquid through passage 18 and thereby ensures that the entire volume of liquid in chamber 16 is transferable to chamber 17 by centrifugation of microtiter plate 11.

In a preferred embodiment at least a portion of or the entire inner surface of the bottom 23 of chamber 16 is a hydrophilic surface or is a surface having a hydrophilic coating (not shown). This feature facilitates the flow of liquid from chamber 16 to passage 18 and thereby ensures that the entire volume of liquid in chamber 16 is transferable to chamber 17 by centrifugation of microtiter plate 11.

In a preferred embodiment at least a portion of or the entire inner surface of the bottom 22 of chamber 17 is a hydrophobic surface or is a surface having a hydrophobic coating (not shown). This feature facilitates the flow of liquid from chamber 16 to passage 18 and thereby ensures that the entire volume of liquid in chamber 16 is transferable to chamber 17 by centrifugation of microtiter plate 11.

As shown by FIGS. 3 to 8, in a preferred embodiment each of cavities 13 tapers towards its bottom end 15, i.e. the cross-section of each cavity 13 diminishes towards the bottom thereof.

As shown by FIG. 9, in a preferred embodiment a solid element 37, which is liquid permeable, is arranged in region 21 of passage 18.

Solid element 37 is e.g. a filter element having a porous structure that allows passage of particles having a size that is smaller than a predetermined size. Such a filter element is made e.g. of glass or of a plastic material or of other similar materials. In a preferred embodiment, solid element 37 is a membrane that allows passage of particles having a size that is smaller than a predetermined size. Such membrane is made e.g. of a plastic material, paper, a gel or a microfiber or of other materials as known to one of ordinary skill in the art.

In a preferred embodiment solid element 37 is a test element, e.g. a chromatographic test element. Test element 37 is e.g. a membrane or a strip similar to a chromatographic strip which in a first step is able to retain a sample material of a certain kind as a sample flows from chamber 16 to chamber 17 through passage 18 and in a subsequent step is able to release that sample material when said test element is brought in contact with a suitable reagent, the released sample and reagent mixture being then transferable to chamber 17 e.g. by centrifugation of plate 11.

In a preferred embodiment solid test element 37 or at least a portion thereof is a coating having hydrophilic properties or hydrophobic properties. The coating is selected based upon the properties of the sample, such as a biomolecule, to be processed, so that the sample, e.g., one or more biomolecules, preferably bind to the coating and/or otherwise do not pass through solid element 37, e.g., the filter.

In a preferred embodiment, solid element 37 is a filter or test element that at least a portion thereof has a coating having hydrophilic or hydrophobil properties.

### EXAMPLE 1 OF A SYSTEM FOR SAMPLE PROCESSING

According to the invention a first system for processing samples having a liquid component or a liquid and a solid component or a liquid and a gel component comprises a microtiter plate 11 of the kind described above with reference to FIGS. 1-9.

In a preferred embodiment this first system further comprises a centrifugation apparatus (not shown in the drawings) for centrifugating the microtiter plate 11.

### EXAMPLE 2 OF A SYSTEM FOR SAMPLE PROCESSING

According to the invention a second system for processing samples having a liquid component or a liquid and a solid component or a liquid and a gel component comprises a microtiter plate 11 of the kind described above with reference to FIGS. 1-8.

In a preferred embodiment this second system further comprises a pipetting tip 33 (shown in FIG. 4) which is insertable into chamber 17 and which is connectable to a pipetting apparatus including overpressure or underpressure generating means.

### EXAMPLE 1 OF A METHOD FOR SAMPLE PROCESSING

According to the invention a first method for processing samples having a liquid component or a liquid and a solid component or a liquid and a gel component comprises
(a) introducing a predetermined volume of a sample having a liquid component or a liquid and a solid component or a liquid and a gel component into chamber 16 of a cavity 13 of a microtiter plate 11 of the above-described type,
(b) centrifugating the microtiter plate 11 for transferring liquid from chamber 16 to chamber 17, the liquid component of sample being thereby entirely removed from first chamber 16 leaving therein only the solid or gel component of the sample.

In a preferred embodiment, the above-mentioned transfer of liquid is effected exclusively by means of centrifugal force generated by centrifugation of the microtiter plate 11. The sample volume transferred from chamber 16 to chamber 17 by centrifugation is in the range of about e.g. 0.05 to 2 microliter.

### EXAMPLE 2 OF A METHOD FOR SAMPLE PROCESSING

According to the invention a second method for processing samples having a liquid component or a liquid and a solid component or a liquid and a gel component comprises
(a) introducing a predetermined volume of a sample having a liquid component or a liquid and a solid component or a liquid and a gel component into a first chamber 16 of a cavity 13 of a microtiter plate 11 of the above-described type,
(b) fluidically connecting one end of a pipetting tip 33 with a second chamber 17 of a cavity 13 of a microtiter plate 11 of the above-described type,
(c) connecting another end of pipetting tip 33 with a pipetting apparatus including underpressure generating means for aspirating and thereby removing the liquid component of said sample from said first chamber 16 and leaving therein only the solid or gel component of the sample.

### EXAMPLE 3 OF A METHOD FOR SAMPLE PROCESSING

According to the invention a third method for processing samples having a liquid component or a liquid and a solid component or a liquid and a gel component comprises
(a) introducing a predetermined volume of a sample having a liquid component or a liquid and a solid component or a liquid and a gel component into a first chamber 16 of a cavity 13 of a microtiter plate 11 of the above-described type,
(b) fluidically connecting one end of a pipetting tip 33 with a second chamber 17 of a cavity 13 of a microtiter plate 11 of the above-described type,
(c) performing pipetting operations on said sample with pipetting tip 13 for either transferring liquid from first chamber 16 to second chamber 17 or for adding and/or removing a liquid to respectively from said first chamber 16 and/or said second chamber 17.

### EXAMPLE OF USE OF THE MICROTITER PLATE, SYSTEM AND METHOD ACCORDING TO THE INVENTION

In a preferred use of the microtiter plate, system and method according to the invention the gel component of the sample contains biomolecules to be analyzed.

Proper use of the microtiter plate according to the invention is subject to the condition that the volume of sample introduced into chamber 16 is smaller than a predetermined maximum value. When this condition is fulfilled only the liquid component of the sample passes through region 21 of passage when transferred from chamber 16 to chamber 17 and any solid or gel component of the sample remains in chamber 16. If the above mentioned condition is not fulfilled, some of the solid and/or gel components of the sample can pass from chamber 16 to chamber 17 through the upper part of passage 18 and the desired separation of the liquid from the solid and/or gel components of the sample is not or not completely achieved. Therefore, in the above described methods the predetermined volume of the sample introduced into chamber 16 is smaller than a predetermined maximum value determined by the shape and the dimensions of the cavity 13, the chambers 16 and 17, and the passage 18.

Although preferred embodiments of the invention have been described using specific terms, such description is for illustrative purposes only, and it is to be understood that changes and variations may be made without departing from the spirit or scope of the following claims.

1. A microtiter plate for processing samples having a liquid component or a liquid and a solid component or a liquid and a gel component, said microtiter plate comprising
a single piece body which is made by injection molding,
said body having an array of cavities and
each of said cavities having an open upper end and a closed bottom end,
each of said cavities having a bottom inner surface and comprising a first chamber for receiving a predetermined volume of a sample to be processed, a second chamber and a passage which fluidically connects said first and second chambers (16, 17) with each other, said passage having a top opening,
said first chamber, said second chamber and said passage having each a bottom inner surface which is portion of the bottom inner surface of said cavity,
a region in the lower part of said passage being adjacent to the bottom end of the cavity, said region being so configured and dimensioned that it allows passage of liquid from one of said chambers to the other only when a centrifugal force is applied to the microtiter plate, but does not allow passage of any solid or gel component the size of which is larger than the width of said region.

2. A microtiter plate according to claim 1, wherein the bottom of said second chamber lies at a lower level than the bottom of said first chamber when the microtiter plate is in horizontal position and the upper ends of said chambers are on the top side of the microtiter plate.

3. A microtiter plate according to claim 1, wherein at least a portion of the inner surface of the bottom of each of said cavities is a hydrophilic or hydrophobic surface, or is a surface having a hydrophilic or hydrophobic coating.

4. A microtiter plate according to claim 1, wherein each of said cavities tapers towards its bottom end.

5. A microtiter plate according to claim 1, wherein said passage has a variable width in a direction extending from said first chamber to said second chamber and said width has a minimum at a zone located between said first and second chambers.

6. A microtiter plate according to claim 1, wherein said region of said passage is a capillary passage adapted for supporting liquid flow from said first chamber to said second chamber.

7. A microtiter plate according to claim 1, wherein said region of said passage is a capillary passage adapted for blocking liquid flow through said passage.

8. A microtiter plate according to claim 1, wherein each of said cavities has an inner surface the cross-section of which is a closed curve, said inner surface having no corner or sharp edge.

9. A microtiter plate according to claim 8, wherein said closed curve has approximately the shape of two circular line portions (27, 28) connected with each other by curved line portions (31, 32).

10. A microtiter plate according to claim 1, wherein said first chamber is adapted for receiving a predetermined volume of a sample having a liquid component or a liquid and a solid component or a liquid and a gel component.

11. A microtiter plate according to claim 1, wherein said second chamber is adapted for receiving a pipetting tip.

12. A microtiter plate according to claim 11, which further comprises first sealing means which seal the contact surface of said tip with the microtiter plate and second sealing means which seal the top opening of said passage.

13. A microtiter plate according to claim 1, wherein said single piece body is made by injection molding of a plastic material.

14. A microtiter plate according to claim 1, wherein said single piece body has standard outer dimensions of a microtiter plate and comprises 384 cavities.

15. A microtiter plate according to claim 1, wherein said single piece body has standard outer dimensions of a microtiter plate and comprises 1536 cavities.

16. A microtiter plate according to claim 1, wherein the cross-section of each of said cavities has a length axis which forms an angle of about 45° with a side edge of the microtiter plate.

17. A microtiter plate according to claim 1, wherein a solid element is arranged in said region of said passage, said solid element being liquid permeable.

18. A microtiter plate according to claim 17, wherein said solid element is a filter element having a porous structure that allows passage of particles having a size that is smaller than a predetermined size, said filter element being made in particular of glass or of a plastic material.

19. A microtiter plate according to claim 17, wherein said solid element is a membrane that allows passage of particles having a size that is smaller than a predetermined size, said membrane being made in particular of a plastic material, paper, a gel or a microfiber.

20. A microtiter plate according to claim 17, wherein said solid element is a test element.

21. A microtiter plate according to claim 17, wherein said solid element is a chromatographic test element.

22. A microtiter plate according to claim 20, wherein said test element or at least a portion thereof is a coating having hydrophilic or hydrophobic properties.

23. A microtiter plate according to claim 1 wherein the inner surface of the bottom of said passage which fluidically connects said first and second chambers (16, 17) with each other has a shape that contributes to maximize the centrifugal force exerted on a sample contained in said first chamber when said microtiter plate is centrifuged by means of a centrifugation apparatus.

24. A microtiter plate according to claim 17 wherein the inner surface of the bottom of said passage which fluidically connects said first and second chambers with each other has a shape that contributes to maximize the centrifugal force exerted on a sample contained in said first chamber when said microtiter plate is centrifuged by means of a centrifugation apparatus.

25. A system for processing samples having a liquid component or a liquid and a solid component or a liquid and a gel component, said system comprising a microtiter plate according to claim 1.

26. The system of claim 25 further comprising a centrifugation apparatus for centrifugating the microtiter plate.

27. The system of claim 25 comprising a pipetting tip which is insertable into said second chamber and which is connectable to a pipetting apparatus including overpressure or underpressure generating means.

28. A method for processing samples having a liquid component or a liquid and a solid component or a liquid and a gel component, said method comprising
(a) introducing a predetermined volume of a sample having a liquid component or a liquid and a solid component or a liquid and a gel component into a first chamber of a cavity of a microtiter plate according to claim 1,
(b) centrifugating the microtiter plate for transferring liquid from said first chamber to said second chamber, the liquid component of said sample being thereby entirely removed from said first chamber leaving therein only the solid or gel component of the sample.

29. The method of claim 28, wherein after said transfer of liquid from said first chamber to said second chamber, the liquid transferred to said second chamber is removed therefrom by a pipetting operation.

30. A method for processing samples having a liquid component or a liquid and a solid component or a liquid and a gel component, said method comprising
(a) introducing a predetermined volume of a sample having a liquid component or a liquid and a solid component or a liquid and a gel component into a first chamber of a cavity of a microtiter plate according to claim 1,
(b) fluidically connecting one end of a pipetting tip with a second chamber of a cavity of a microtiter plate according to any of claims 1 to 23,
(c) performing pipetting operations on said sample with said pipetting tip for either transferring liquid from said first chamber to said second chamber or for adding and/or removing a liquid to respectively from said first chamber and/or said second chamber.

31. The method of claim 28, wherein said gel component of the sample contains biomolecules to be analyzed.

32. A system for processing samples having a liquid component or a liquid and a solid component or a liquid and a gel component, said system comprising a microtiter plate according to claim 24.

33. The system of claim 32 further comprising a centrifugation apparatus for centrifugating the microtiter plate.

34. The system of claim 32 comprising a pipetting tip which is insertable into said second chamber and which is connectable to a pipetting apparatus including overpressure or underpressure generating means.

35. A method for processing samples having a liquid component or a liquid and a solid component or a liquid and a gel component, said method comprising
(a) introducing a predetermined volume of a sample having a liquid component or a liquid and a solid component or a liquid and a gel component into a first chamber of a cavity of a microtiter plate according to claim 24,
(b) centrifugating the microtiter plate for transferring liquid from said first chamber to said second chamber, the liquid component of said sample being thereby entirely removed from said first chamber leaving therein only the solid or gel component of the sample.

36. The method of claim 35, wherein after said transfer of liquid from said first chamber to said second chamber, the liquid transferred to said second chamber is removed therefrom by a pipetting operation.

37. A method for processing samples having a liquid component or a liquid and a solid component or a liquid and a gel component, said method comprising
(a) introducing a predetermined volume of a sample having a liquid component or a liquid and a solid component or a liquid and a gel component into a first chamber of a cavity of a microtiter plate according to claim 24,
(b) fluidically connecting one end of a pipetting tip with a second chamber of a cavity of a microtiter plate according to any of claims 1 to 23,
(c) performing pipetting operations on said sample with said pipetting tip for either transferring liquid from said first chamber to said second chamber or for adding and/or removing a liquid to respectively from said first chamber and/or said second chamber.

38. The method of claim 37, wherein said gel component of the sample contains biomolecules to be analyzed.
